(19) United States
(12) Patent Application Publication
(10) Pub. No.: US 2008/0061561 A1
(43) Pub. Date: Mar. 13, 2008

(54) Automatic gate lock

(76) Inventor: Yuri Uryasov, Garfield, NJ (US)

Correspondence Address: Klaus P. Stoffel;Wolff & Samson PC, One Boland Drive, West Orange, NJ, 07052, US

(21) Appl. No.: 11/516,977

(22) Filed: Sep. 7, 2006

(51) Int. Cl. E05C 7/00

(52) U.S. Cl. 292/40

(57) ABSTRACT

An automatic gate opener lock. The gate opener lock has a locking bolt which is moved between locked and unlocked positions by the movement of a swing arm of an automatic gate opener. To prevent movement of the locking bolt toward its locked position before the gate is closed, springs are arranged for resisting movement in that direction. The springs have a combined resistive force greater than the force required to move the gate. Only when the gate is closed, and the force from the swing arm may no longer be dissipated through gate movement, is the combined force of the springs overcome, and the locking bolt moved into the locked position.

### BACKGROUND OF THE INVENTION

1. Field of the Invention

The present invention relates to remotely controlled devices for controlling access through gates and doors.

2. Discussion of the Background Art

Devices for remotely opening and closing gates and doors are known in the art, as are devices for remotely locking gates and doors. Presently, electrically operated gate opening and closing devices are in widespread use. These gate opening and closing devices are of limited use for preventing persons from entering or exiting, because the devices do not actually lock the free-swinging end of the gate adjacent to the fence post. Therefore, particularly with a wide gate which may be easily bent, a person may merely push or pull the free-swinging edge of a closed gate enough to pass through. Separate remotely-controlled locking devices are often installed on such gates to solve this problem. A person requiring remotely controlled opening, closing, and locking will, therefore, be forced to purchase a rather expensive remotely controlled locking device in addition to the likewise expensive remotely-controlled gate opening and closing device.

It would be advantageous to devise a simple and inexpensive apparatus which adapts existing gate opening and closing devices to lock the free-swinging end of the gates or doors on which the devices are installed.

### SUMMARY OF THE INVENTION

An automatic gate opener lock. The gate opener lock has a locking bolt which is moved between locked and unlocked positions by the movement of swing arm of an automatic gate opener. To prevent movement of the locking bolt toward its locked position before the gate is closed, a spring is arranged for resisting movement in that direction. The spring has a resistive force greater than the force required to move the gate. Only when the gate is closed, and the force from the swing arm may no longer be dissipated through gate movement, is the force of the spring overcome, and the locking bolt moved into the locked position.

Further advantages, features and details of the invention are revealed in the following description of preferred exemplified embodiments and with the aid of the drawings.

### BRIEF DESCRIPTION OF THE DRAWINGS

FIG. 1 shows the locking apparatus mounted on a swinging outdoor gate.

FIG. 2 shows a top view of the locking apparatus mounted on a swinging outdoor gate.

FIG. 2a shows an alternate view of the rod mount.

FIG. 3 shows an alternate embodiment of the locking apparatus mounted on a swinging outdoor gate.

FIG. 4 is an enlarged view of the alternate embodiment of the locking apparatus in FIG. 3.

FIG. 5 shows a second alternate embodiment of the locking apparatus.

FIGS. 6a and 6b show enlarged views of the second alternate embodiment of the locking apparatus.

### DETAILED DESCRIPTION OF THE INVENTION

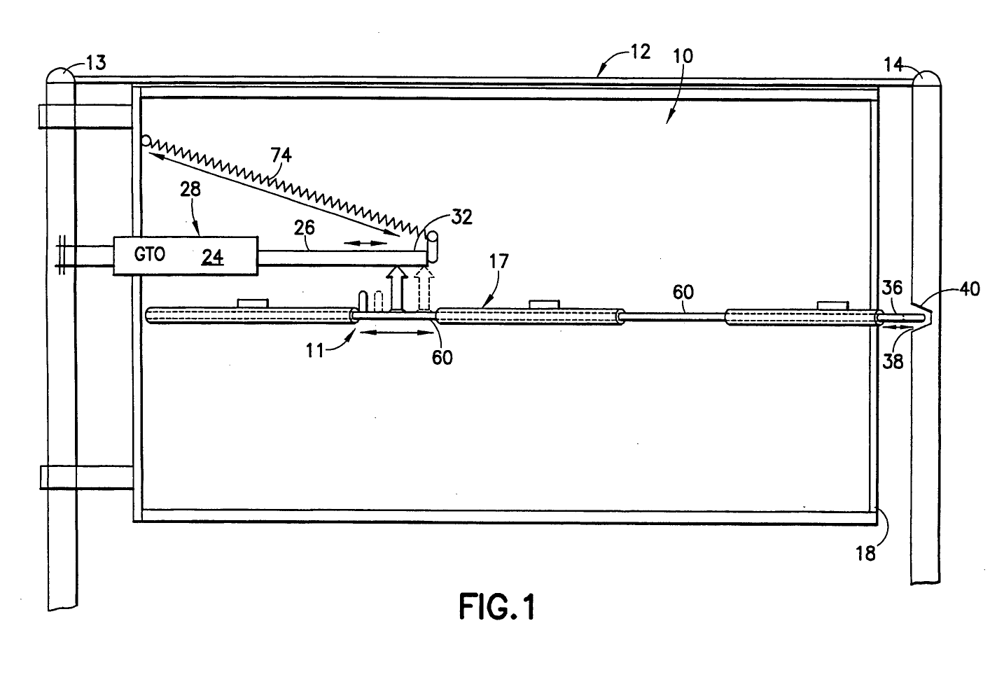

The present invention comprises a locking apparatus for an automatic gate Referring to FIG. 1, the system consisting of the opening and closing device and the locking apparatus is referred to generally by the reference numeral 10. The locking apparatus is referred to by the reference numeral 11. The system 10 is shown installed on an outdoor fence having a radially-swinging gate 12. The gate 12 lies between two stationary posts, 13 and 14. The jamb post 14 stands adjacent to the swinging edge 18 of the gate 12. The support post 13 stands adjacent to and supports the pivotal end 22 of gate 12. The gate opener 24 is shown mounted to the post 13.

Referring again to FIG. 1, the gate opener 24 has a swing arm 26 attached to or provided as a piston of a cylinder 28. When the gate 12 is to be closed, the gate opener 24 is activated and the swing arm 26 travels radially in a direction which pushes the gate 12 toward its closed position. As the swing arm 26 travels, the piston extends outwardly toward the swinging edge 18 of the gate 12. The gate opener 24 is designed so that the piston continues to extend after the gate 12 reaches a fully closed position. The extension stops when a pre-determined tension is reached. When the gate 12 is to be opened, the process is reversed with the piston retracting and the swing arm 26 traveling radially in the reverse direction.

Without the addition of the locking apparatus 11, the distal end 32 of the swing arm 26 is typically attached directly to the gate 12. Here, the distal end 32 of the swing arm 26 is pivotally attached to a bar 15. The bar 15 is mounted inside a tube 17 so that the bar 15 may move a certain distance in the tube. The extension of the arm 26 after the gate 12 is closed, as mentioned above, usually only creates tension on the gate 12 to help hold it in its closed position. The present invention uses this after-closing movement to move the bar 15 between an extended-locked position and a retracted-unlocked position. In the extended-locked position, a distal end 36 of the bar 15 extends through a hole 38 of a bolt receiver 40. The bolt receiver 40 is mounted on the post 14.

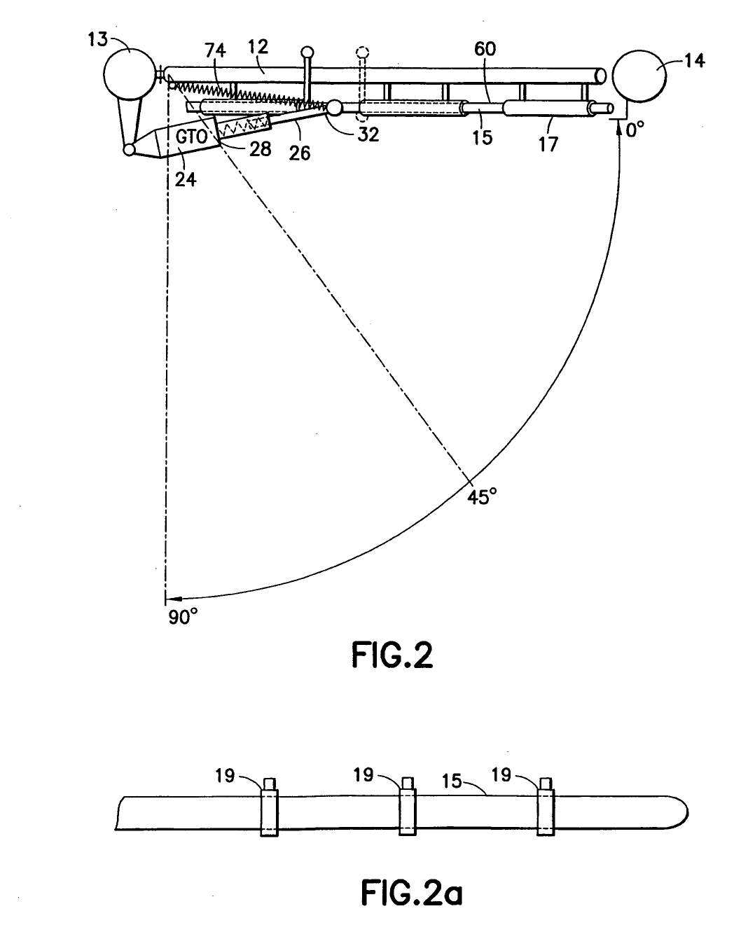

Referring in combination to FIGS. 1, and 2, the tube 17 is attached to the gate 12. The tube 17 serves as a mounting and support platform for the bar 15. The tube 17 of the preferred embodiment is constructed of tubular metal which is attached to the gate 12 so that the tube 17 is horizontally oriented and abuts the gate 12.

Referring again to FIGS. 1, and 2 in combination, the tube 17 has a plurality of slots 60 disposed along its axis. When mounted in this manner, the bar 15, regardless of the direction of force applied to it, may only move, if at all, parallel with the longitudinal axis of the tube 17. The length of the slots 60 of the force tube 17 are such that the bar 15 may move sufficiently to move the bar 15 between its locked and unlocked positions; that is, to move the distal end 36 in and out of the hole 38 in the bolt receiver 40.

FIG. 2a shows an alternate embodiment of attaching the bar 15 to the gate 12. The bar 15 is mounted inside rings 19 so that the bar 15 may move a certain distance. This cuts down on friction with the bar 15 and keeps debris and ice from forming in the tube 17, while keeping the bar 15 from moving. The rings 19 are attached to the gate 12. The rings 19 serve as a mounting and support platform for the bar 15. The rings 19 are constructed of, for example, circular metal and are attached to the gate 12 so that the rings 19 are horizontally oriented and abut the gate 12. When mounted in this manner, the bar 15, regardless of the direction of force applied to it, may only move, if at all, parallel with the central axis of the rings 19. The position of the rings 19 is such that the bar 15 may move sufficiently to move the bar 15 between its locked and unlocked positions; that is, to move the distal end 36 in and out of the hole 38 in the bolt receiver 40.

The bar 15 is, in the preferred embodiment, a rod-like member. The length of the bar 15 is determined by the width of the gate 12. As the swing arm 26 pushes against the bar 15 while the gate 12 is being closed, the bar 15 tends to move toward the swinging edge 18 of the gate 12, and consequently tends to push the bar 15 toward its locked position. A mechanism is necessary for preventing extension of the bar 15 before the gate 12 is fully closed. The preferred embodiment of the present invention includes a spring to accomplish this.

A spring 74 has one end attached to an edge of the gate adjacent the support post 13, and another end connected to the distal end 32 of the swing arm 26 or the bar 15. In this configuration, the spring 74 resists movement of the bar 15 toward its locked position. The resistance of the spring 74 to stretching exerts a force against the extension of the distal end 36 toward its locked position slightly greater than the force required to move the gate 12 toward its closed position. Therefore, before the gate 12 is fully closed, when the force exerted by the cylinder 28 may be dissipated through movement of the gate 12, the distal end 36 remains in its retracted-unlocked position. Only when the gate 12 is fully closed and the force exerted by the cylinder 28 may no longer be dissipated by movement of the gate 12, is the combined resistive force of the spring 74 overcome allowing the distal end 36 to extend into its locked position. The spring 74 pulls the gate closed ahead of the force exerted by the cylinder 28, keeping the bar 15 in a retracted position. When the gate 12 reaches its stopping point, the force of the spring 74 is overcome by the cylinder 28, and the bar 15 is moved into the locking position.

Operation of the gate opener 24 having the locking apparatus 11 added is, from a user's standpoint, no different than without the locking apparatus 11; a user merely actuates the remote control (not shown) of the gate opener 24. When the gate 12 is open, the gate opener 24 responds by moving the swing arm 26 in a direction which pushes the gate 12 closed. As the swing arm 26 moves it gradually extends from the cylinder 28. The extension of the swing arm 26 and, to a lesser extent, the radial movement of the swing arm 26 in certain positions, tend to move the force bar 15 toward its locked position. Because of the spring 74 as above described, the forces exerted on the bar 15 are translated instead into movement of the gate 12. When the gate 12 may no longer move toward its closed position, whether by fully closing or by reaching an obstruction which prevents it from moving further, the resistive forces of the spring 74 are overcome and the bar 15 extends into its locked position. When properly closed, the distal end 36 of the bar 15 extends into the hole 38 of the bolt receiver 40 thereby locking the gate 12.

When the gate 12 is to be opened, the user again actuates the remote control (not shown). The swing arm 26 retracts into the cylinder 28, the bar 15 pulls the distal end 36 from the hole 38 of the bolt receiver 40, and the gate 12 is then free to swing open under force from the cylinder 28 and the swing arm 26.

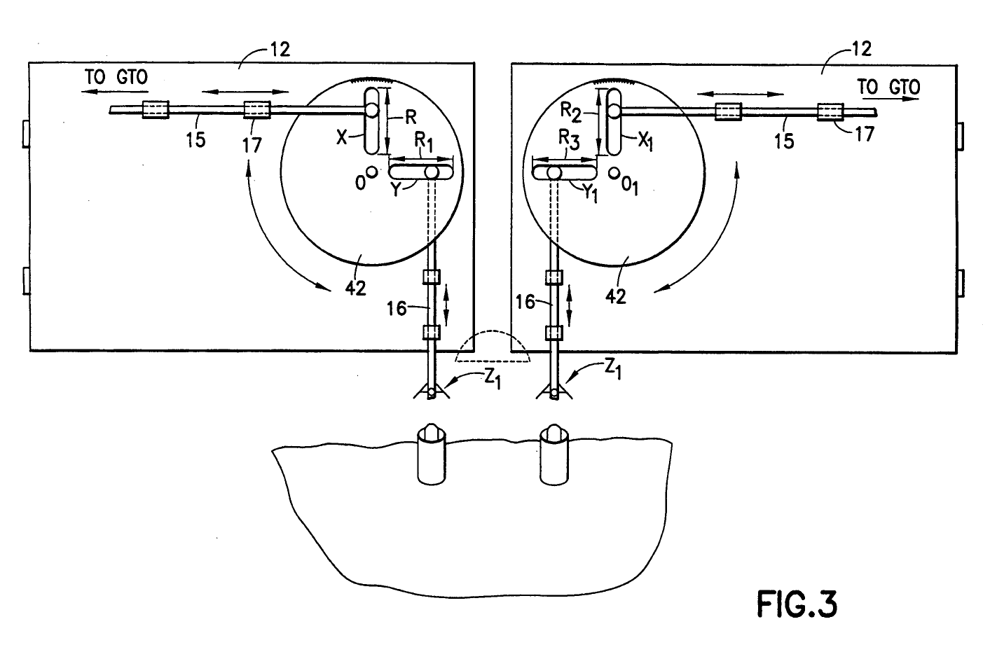

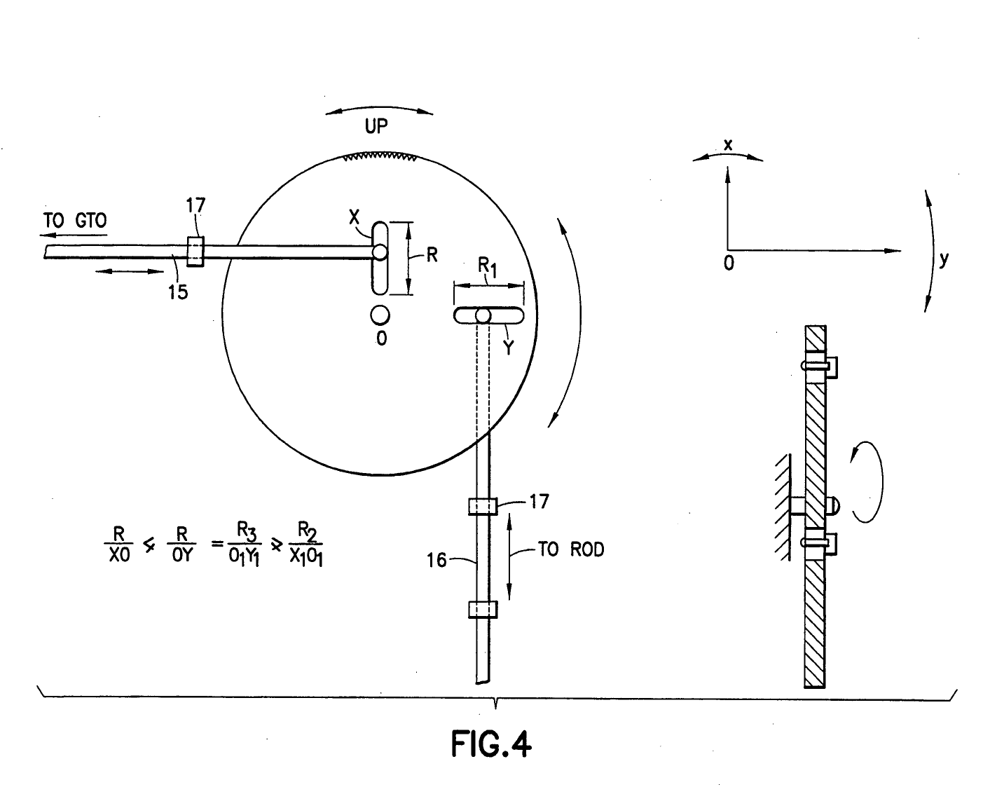

Referring to FIGS. 3, and 4, an alternative embodiment of the present invention includes a locking apparatus 11 which accommodates two gates 12. Although described in connection with two gates the system can also be used with a single gate. The bars 15 are attached to flat disks 42. The flat disks 42 have a slot x in which an end of the bar 15 is slidably arranged. Disks 42 also have a slot y, in which an end of a second locking bar 16 is slidably arranged. The distance from the center of disk 42 to the slot x is less than the distance from the center of disk 42 to the slot y.

When the gate 12 is closed, and the spring force is overcome, as discussed above, the bar 15 begins to exert force on the disk 42 by pressing on the wall of the slot x. When this happens, the disk 42 begins to rotate, exerting force, via the slot y, on the bar 16, forcing it in a downward, into a receiver (not shown) located beneath the gate 12. When the gate 12 is opened, force is exerted by the bar 15 on the slot x of disk 42, thereby causing the disk 42 to rotate. The disk 42 then exerts force on the bar 16 via the slot y, pulling the rod 16 in an upwards direction and thereby releasing the lock.

In the same manner as with the previous embodiment, the bar 16 does not extend until the force from the swing arm 26 may no longer be dissipated through movement of the gate 12. When the swing arm 26 moves to open the gate 12, the bar 16 retracts under force from the spring 74.

Although the above embodiment is described with the bar 16 extending downwardly, it is also possible to have the bar 16 extend upwardly to engage in a receiver mounted above the gate.

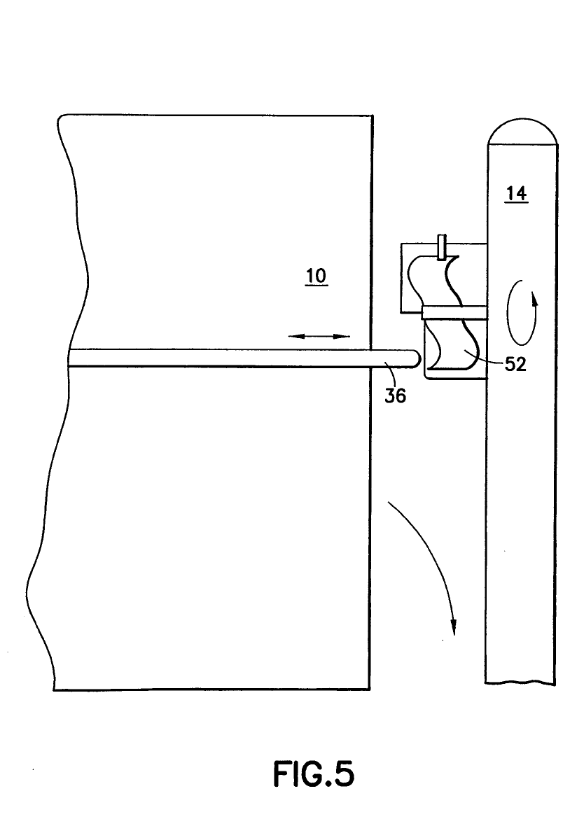

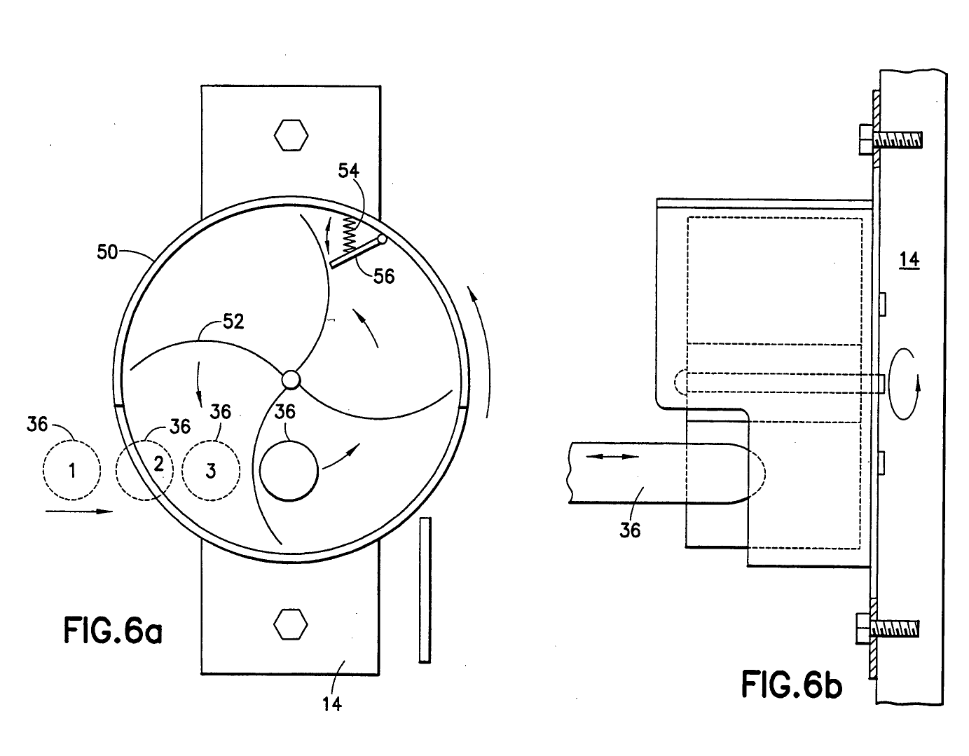

Referring to FIGS. 5, and 6, another embodiment of the present invention includes a locking apparatus 50 which is attached to the post 14. The locking apparatus 50 is comprised of a propeller 52, a spring 54 and a stopper 56. When the gate 12 is being closed, as described above, wind or some other force may cause the gate to be pushed closed with less force than normal, causing the gate to be closed with lock rod 36 extended.

When this happens, the gate 12 is closed, and the bar 15 is extended, and the end 36 meets one of the blades of the propeller 52. The propeller 52 is allowed to turn in a counter clockwise direction by the spring 54 and the stopper 56, until the gate 12 is in the closed position, but is not allowed to turn in a clockwise direction, releasing the gate, so the gate remains locked.

When gate 12 is opened, force is exerted on the bar 15 thereby causing the end 36 of the rod to be pulled out of the locking apparatus 50, allowing the gate to open. In the same manner as previously described, the swing arm 26 moves to open the gate 12, which allows the bar 15 to retract under force from the spring 74.

The locking apparatus 50 can be utilized in combination with the bolt receiver 40 or in place of the bolt receiver.

Although described in connection with a gate, the inventive locking mechanism is equally applicable to a wide variety of systems ranging from doors to hospitals to aircraft landing gear. Basically, the invention can be used in virtually any system where a structure can be moved between at least two positions and needs to be locked in an end position.

While the invention has been described in connection with the preferred embodiment, it is not intended to limit the invention to the particular forms or practices set forth, but, on the contrary, it is intended to cover such alternatives, modifications, and equivalents as may be included within the spirit and scope of the invention as defined as the appended claims.

I claim:

1. A locking apparatus for a swinging gate, comprising:
a swing arm powered opener;
a locking bolt slidably supportable on the swinging gate so that said locking bolt is movable between an extended position and a retracted position, said swing arm powered opener being extendable to produce a first force sufficient to move the gate from an open position to a closed position and to move said locking bolt to said extended position, and retractable to produce a second force sufficient to move the gate from the closed position to the open position and to move said locking bolt to said retracted position, said swing arm opener being attached to said locking bolt so that said first force is in a direction of extending said locking bolt and so that said second force is in a direction of retracting said locking bolt; and
resisting means engaging said locking bolt for preventing said locking bolt from extending into said extended position until the gate reaches the closed position and for retracting said locking bolt before said second force moves the gate toward the open position, said first force on said locking bolt being substantially dissipated through movement of the gate until the gate reaches the closed position so that said locking bolt remains retracted during movement of the gate, said first force extending said locking bolt when said first force is no longer dissipated by gate movement.

2. A locking apparatus according to claim 1, wherein the resisting means includes a spring having one end connected to the locking bolt and another end attached to the gate so that said spring must be stretched for said locking bolt to extend toward said extended position.

3. The locking apparatus according to claim 2, further comprising an adjustable gate spring mount for adjustably attaching the end of said spring to said locking bolt.

4. A locking apparatus for a swinging gate having a swing arm powered gate opener wherein the swing arm extends and retracts for respectively moving the gate between closed and open positions, comprising:
a locking bolt slidably supportable on the swinging gate so that said locking bolt is movable between an extended position and a retracted position;
force directing means slidably supported on said gate so that said force directing means is only movable substantially parallel with the longitudinal axis of said locking bolt, an end of said locking bolt being attached to a first end of said force directing means, and the swing arm being pivotally attached to a second end of said force directing means, said force directing means being operative to direct a variably-directed first force from extension of said swing arm and a variably-directed second force from retraction of said swing arm in orientations parallel to said longitudinal axis of said locking bolt for preventing binding of said locking bolt as said locking bolt moves in response to said first and said second forces and for transmitting said first and second forces to said locking bolt, the said swing arm being attached to the gate only through said force directing means so that said first force is directed for extending said locking bolt and so that said second force is directed for retracting said locking bolt; and
resisting means engaging said locking bolt and the gate for preventing said locking bolt from extending into said extended position until the gate reaches the closed position, said resisting means exerting a third force against extension of said locking bolt, said third force being greater than an amount of said first force required to move the gate toward the closed position, said first force being substantially dissipated through movement of the gate until the gate reaches the closed position, said first force overcoming said third force and extending said locking bolt when said first force is no longer dissipated through said gate movement.

5. The locking apparatus according to claim 4, wherein said resisting means comprises a first spring and a second spring, said first spring having, at a substantially relaxed state, a first resistance to stretching, said second spring having, at a substantially relaxed state, a second resistance to compression, a sum of said first and second resistances of said springs being greater than said amount of said first force required to move the gate toward the closed position, said first spring being attached to said force directing means and to the gate so that said first spring must be stretched for said force directing means to move said locking bolt toward said extended position, said second spring engaging said locking bolt and the gate so that said second spring must be compressed for said locking bolt to extend toward said extended position.

6. The locking apparatus according to claim 4, wherein first end of said first spring is attached to said force directing means.

7. A locking apparatus for a swinging gate having a swing arm powered gate opener wherein the swing arm exerts a first force substantially perpendicular to a face of the gate for moving the gate toward a closed position and exerts a second force substantially perpendicular to the gate face for moving the gate toward an open position, comprising:
a locking bolt slidably supported on the swinging gate so as to be movable between an extended position for engaging bolt receiving means and a retracted position;
force directing means mounted on the gate, said force directing means having a disk operatively engaged to direct the first and second force substantially vertically, from said swing arm to said locking bolt;
resisting means engaged with the locking bolt and the gate so as to prevent extension of the locking bolt prior to the gate reaching the closed position, said force directing means being mounted so that the swing arm moves said force directing means, and said force directing means moves said locking bolt between said extended and said retracted positions, the first force being substantially dissipated through movement of the gate toward said closed position until the gate reaches said closed position, the first force overcoming a spring force of the resisting means and extending said locking bolt when said first force is no longer dissipated through movement of the gate.

8. The locking apparatus according to claim 7, wherein the resisting means comprises a spring engaging said gate and said locking bolt so that said spring must be stretched for said locking bolt to extend toward said extended position.

9. The locking apparatus according to claim 7, wherein said resisting means comprises a spring, said spring force being greater than the first force required to move the gate toward the closed position.

10. The locking apparatus according to claim 9, further comprising an abutment arranged so as to limit travel of said locking bolt.

11. The locking apparatus according to claim 10, further comprising a locking mechanism operative to lock the gate when the gate is closed with said locking bolt extended.

12. The locking apparatus according to claim 11, wherein said locking mechanism comprises a propeller which is allowed to move in only one direction so as to capture the extended locking bolt and lock the gate in place.

13. A locking apparatus for a swinging gate having a swing arm powered gate opener wherein the swing arm extends and retracts for respectively moving the gate between closed and open positions, comprising:
a locking bolt slidably supported on the swinging gate so that said locking bolt may move between an extended position for engaging bolt receiving means and a retracted position; and
force directing means slidably supported on the gate so as to only be movable substantially parallel with a longitudinal axis of said locking bolt, an end of said locking bolt being attached to a first end of said force directing means, the swing arm being pivotally attached to said force directing means, said force directing means being arranged to translate variably directed force from extension of the swing arm in orientations parallel to said longitudinal axis of said locking bolt for preventing binding of said locking bolt as said locking bolt moves in response to the force and for transmitting the force to said locking bolt, said swing arm being attached to the gate by said force directing means so that said force is directed for extending said locking bolt and so that said force is directed for retracting said locking bolt.

14. The locking apparatus according to claim 1, and further comprising bolt receiving means for receiving the locking bolt in th extended position.

15. The locking apparatus according to claim 1, and further comprising a bar slidably attached to a surface of the gate, the bar having a distal end attached to the locking bolt and a proximal end, the gate opener being attached in a vicinity of the proximal end of the bar.

16. The locking apparatus according to claim 15, and further comprising a slide guide mounted to the surface of the gate, the bar being slidably arranged in the slide guide so that the bar slides in a horizontal direction.

17. The locking apparatus according to claim 16, wherein the slide guide is made up of tube segments attached to the gate.

18. The locking apparatus according to claim 16, wherein the slide guide includes a plurality of rings mounted to the gate, the bar being arranged to pass through the rings.

19. An assembly, comprising:
a gate pivotably mounted to a hinged jam;
a swing arm powered opener mounted between the hinged jam and the gate for moving the gate between an open position and a closed position;
a locking bolt slidably supported on the gate so that the bolt is movable between an extended position and a retracted position, the swing arm opener being attached to the locking bolt so that during opening a first force is directed in a direction of extending the locking bolt and, during closing a second force is directed in a direction of retracting a locking bolt, the locking bolt in the extended position extending from an edge of the gate opposite an edge of the gate at the hinge jam; and
means for resisting movement of locking bolt, said resisting means being connected between the locking bolt and the gate so as to prevent the locking bolt from extending into the extended position until the gate reaches the closed position and for retracting the locking bolt before the second force moves the gate toward the open position, the first force on the locking bolt being substantially dissipated by movement of the gate until the gate reaches the closed position so that the locking bolt remains retracted during movement of the gate, the first force extending the locking bolt when the first force is no longer dissipated by bolt movement.
